(19) United States
(12) Patent Application Publication
(10) Pub. No.: US 2013/0204593 A1
(43) Pub. Date: Aug. 8, 2013

(54) Computational Fluid Dynamics Systems and Methods of Use Thereof

(71) Applicant: Panduit Corp., Tinley Park, IL (US)

(72) Inventors: Brendan F. Doorhy, Westmont, IL (US); Sambodhi Chatterjee, Naperville, IL (US); Zeshun Cai, Skokie, IL (US); Thomas M. Peddle, Aurora, IL (US); Saurabh K. Shrivastava, Lemont, IL (US)

(73) Assignee: PANDUIT CORP., Tinley Park, IL (US)

(21) Appl. No.: 13/754,100

(22) Filed: Jan. 30, 2013

Related U.S. Application Data
(60) Provisional application No. 61/592,633, filed on Jan. 31, 2012.

(51) Int. Cl. G06F 17/50

(52) U.S. Cl. CPC G06F 17/50
USPC 703/2

(57) ABSTRACT

The present invention generally relates to systems and methods for evaluating and/or predicting thermodynamic behavior within a particular area, and more specifically, to systems and methods which, at least in some embodiments, use computational fluid dynamics to compute and/or predict thermodynamic behavior of data centers and the like. Embodiments of the present invention include the ability to validate the calibration of computational models in order to improve output accuracy.

### CROSS-REFERENCE TO RELATED APPLICATIONS

This application claims the benefit of U.S. Provisional Patent Application No. 61/592,633, filed on Jan. 31, 2012, which is incorporated herein by reference in its entirety.

### FIELD OF INVENTION

The present invention generally relates to systems and methods for evaluating and/or predicting thermodynamic behavior within a particular area, and more specifically, to systems and methods which, at least in some embodiments, use computational fluid dynamics to compute and/or predict thermodynamic behavior of data centers and the like.

### BACKGROUND OF THE INVENTION

Computational fluid dynamics (CFD) has been around since the early 20th century. However, the application of CFD analysis in data centers is a relatively new occurrence. In data centers, temperature and airflow are invisible and non-linear, necessitating the need for computational systems to visualize thermal performance. Even though CFD modeling is an effective way to optimize data center airflow configurations, the available systems which employ such modeling can have a number of drawbacks. For example, these systems often come at a steep price of setting up an initial CFD model. Additionally, the lack of dynamic surveying of data centers and a lack of efficient CFD model validation can significantly impact the accuracy of a CFD output report.

Thus, there is a need for improved CDF modeling systems and methods which may be implemented in environments such as data centers.

### SUMMARY OF THE INVENTION

Accordingly, embodiments of the present invention are generally directed to CFD modeling systems for use in environments such as data centers and methods of use thereof.

In one embodiment, the present invention is a system for maintaining accurate CFD results in a given data center room over time by providing a dynamic thermal analysis modeling update mechanism as data center changes occur. This technique reduces setup costs, improves CFD accuracy, and helps make informed decisions that may increase the efficiency and reduce the costs of data center operations.

In another embodiment the present invention is a system for computing thermodynamic behavior within a data center, the system including: an electronic device for executing at least one module thereon, the at least one module including: a data acquisition module for obtaining and storing input information, the input information including at least one of data center asset information, data center physical characteristics, asset tracking information, and environmental condition information; a data solving module for accepting and analyzing the input information to output an output data packet, the output data packet comprising a predicted thermodynamic behavior model of the data center; a data model validation module for validating the accuracy of the predicted thermodynamic behavior model of the data center against actual behavior of the data center; and a data model output module for formatting and outputting the output data packet.

In yet another embodiment, the present invention is a method of computing thermodynamic behavior within a data center, the method including the steps of: obtaining and storing on an electronic device input information, the input information including at least one of data center asset information, data center physical characteristics, asset tracking information, and environmental condition information; analyzing the input information to produce an output data packet, the output data packet comprising a predicted thermodynamic behavior model of the data center; validating the accuracy of the predicted thermodynamic behavior model of the data center against actual behavior of the data center; and formatting and outputting the output data packet.

In still yet another embodiment, the present invention is a system for computing thermodynamic behavior within a data center, the system including: an electronic device for executing computer software thereon; and an infrastructure management software executed on the electronic device. The infrastructure management software includes: a data acquisition module for obtaining and storing input information, the input information including at least one of data center asset information, data center physical characteristics, asset tracking information, and environmental condition information; a data solving module for accepting and analyzing the input information to output an output data packet, the output data packet comprising a predicted thermodynamic behavior model of the data center; a data model validation module for validating the accuracy of the predicted thermodynamic behavior model of the data center against actual behavior of the data center; and a data model output module for formatting and outputting the output data packet.

These and other features, aspects, and advantages of the present invention will become better-understood with reference to the following drawings, description, and any claims that may follow.

### BRIEF DESCRIPTION OF THE DRAWINGS

FIG. 1 illustrates a process flow for a system and/or methods in accordance with an embodiment of the present invention.

FIGS. 2A and 2B illustrate examples of CFD output models generated in accordance with an embodiment of the present invention.

### DETAILED DESCRIPTION

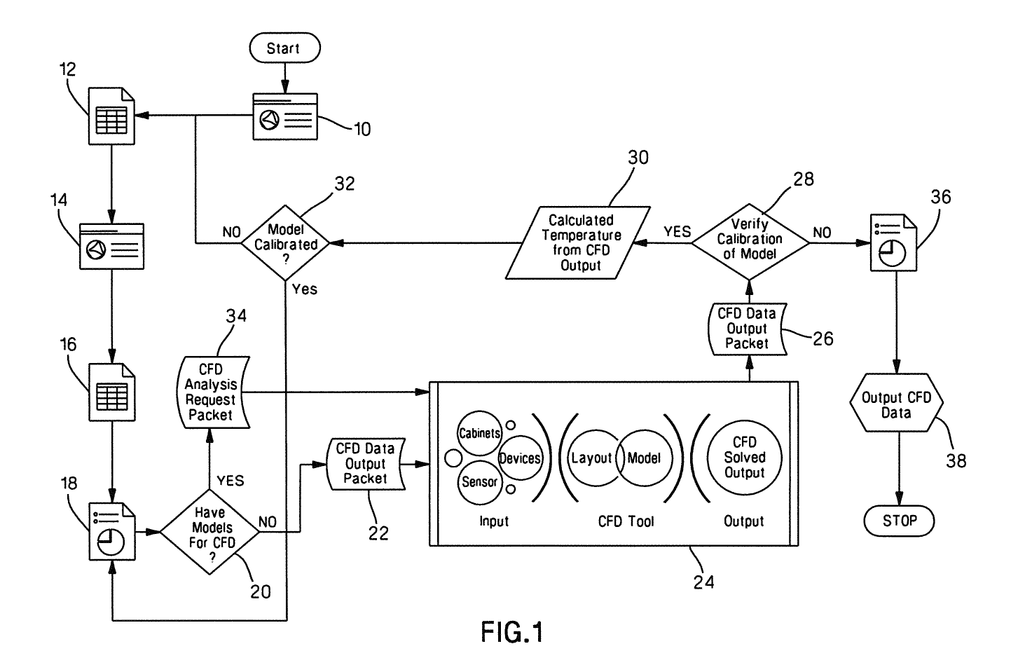

FIG. 1 depicts an exemplary embodiment of a process flow for a system for initial CFD model creation, validation of model accuracy, and use of said model for evaluation of equipment placement alternatives that appropriately meet a user's needs. Such a system can be a stand-alone system or it can be implemented as a part of infrastructure management software (IMS) (as shown in FIG. 1) like Panduit's Physical Infrastructure Manager™ (PIM™).

To initiate a CFD model analysis, a user starts by creating an entry 10 in IMS, where physical and/or logical characteristics regarding data center objects, such as cabinets, network equipment/devices, conditioning units etc., and the location or mapping characteristics of the data center can be stored. This information may be stored in one or multiple IMS file(s), or it may be a subset of a separate database file.

During the next step 12, specific data center object information is entered into the IMS. In one embodiment, this information can be inputted manually by a user. In another embodiment, this step may be performed by importing object information from another file which already contains such information. In yet another embodiment, the necessary information may be gathered by way of sensors or other discovery apparatuses/systems which can detect various characteristics of the data center objects and report (statically or dynamically) said information to IMS.

At the next step 14, the user enters physical characteristics of the data center such as its physical layout and locations of air-flow obstructions. Again, depending on the embodiment, this information may be entered manually by a user or automatically by way of importation from another file (such as a floor plan created in a computer-aided design application), sensor data, discovery mechanisms, or other available means. The automatic importation may be either static or dynamic.

The data center object information entered in step 12 and the physical characteristics entered in step 14 may include one or more of: a map of the location of the equipment in the data center; data center room dimensions; air cooling unit locations in the room, supply air temperatures and airflows; rack/cabinet locations and orientation in the room; rack/cabinet inlet and outlet temperatures; heat-generating equipment placement in racks; power consumed by equipment and heat generated by such power consumption; airflow readings through the heat generating equipment; locations of blanking panels and/or obstructions, underflow, and ceiling obstructions; and floor tile perforation details. However, recordation of other information and characteristics may be more desirable depending on the specific application.

In a typical datacenter, equipment such as cooling units, floor grills, and PDUs are non-moving objects. However, heat-generating assets, such as servers and switches, may frequently move from cabinet to cabinet or even out of the data center. Some IMSs (like PIM™) have the capability of tracking the movement of the heat-generating assets and obstructions via an asset tracking function. Additional information on PIM™ Asset Tracking is provided in application Ser. No. 13/586,569 filed Aug. 15, 2012, entitled “INTEGRATED ASSET TRACKING, TASK MANAGER, AND VIRTUAL CONTAINER FOR DATA CENTER MANAGEMENT” which is incorporated herein by reference in its entirety. Since in some embodiments, objects in a data center may not be statically placed, information regarding the tracking of present and future data center objects can be inputted at step 16. This can allow the present invention to dynamically monitor trackable environmental and asset attributes, and update the input information for the CFD model in real or near real time.

Next, at step 18, the IMS is provided with environmental condition information for a particular data center. In one embodiment, this information is obtained by way of one or more sensors located in the data center, where these sensors are able to communicate necessary data to the IMS. In one embodiment, the environmental condition information gathered includes at least one of: room temperature, power consumption, and room humidity.

Once all needed information is obtained from steps 12-18, the IMS proceeds to determine whether a corresponding CFD model is already available 20. If such model is available, a CFD analysis request packet 34 is sent to the CFD solving module 24 to invoke the existing CFD model and use that model to generate an output. If a corresponding CFD model is not available, a CFD model request packet 22 is sent to the CFD solving module 24 instructing the solving module 24 to generate a new CFD model and then use that model to generate an output. Both packets in steps 22 and 34 include data gathered during earlier steps.

Upon receiving the previously gathered data, the CFD solving module 24 uses CFD modeling techniques to predict temperature and return airflow patterns within the data center. These results are outputted as a CFD data output packet 26, and are then used to determine if the calibration of the CFD model needs to be verified 28. In one embodiment, this determination can be made by a user. In another embodiment, automatic verification of calibration may be required if some condition is met (for example, if no corresponding CDF model was found in step 20). If calibration verification is required, the CFD data output is fed into module 30 where this data is saved as a newly created CFD model if no CFD model existed prior, or the data is incorporated as an update into an existing CFD model if a previous corresponding model was found to exist. Thereafter, the output data is used to determine whether the CFD model is calibrated in step 32.

In one embodiment, the CFD model calibration verification module implemented in step 32 applies a root mean square error method to the above-noted CFD data output packet 26 in order to compute an error value. If the calculated value is at or below a defined threshold, the model will not be calibrated. If, on the other hand, the calculated error value is above a defined threshold, the system will re-gather the data center and asset information, and generate an output based on that information to calibrate the virtual facility further. As used herein, the term “virtual facility” can refer to any computational model, in discrete or continuous time, which represents the relationship (or domain mapping) between physical elements of a data center room and its corresponding observable and predictable thermodynamic behavior (temperature, airflow, air pressure, heat energy, power, etc.).

In one embodiment, the accuracy of a model is checked by calculating the root mean square difference between measured and calculated sensor readings. The root mean square difference requires two sets of inputs: the calculated sensor reading(s) generated from the CFD solving module 24 and the actual measured reading(s) obtained from the sensor(s) positioned in a data center. This method of calculating such a root mean square difference works as follows (in this example there are n calculated sensor readings and n measured readings):
take the difference of each corresponding calculated and measured readings:

cal_{—}1−mea_{—}1, cal_{—}2−mea_{—}2, . . . , cal_n−mea_n;
square each difference: (cal_{—}1−mea_{—}1)², (cal_{—}2−mea_{—}2)², . . . , (cal_n−mea_n)²;
sum all the squared results resulting in a value w;
divide w by the number of readings, which is n in this case, resulting in value y; and
take a square root of y.

Mathematically stated, the formula looks as follows:

$${θ}_{1} = [ \begin{matrix}{x}_{1 , 1} \\ {x}_{1 , 2} \\ ⋮ \\ {x}_{1 , n}\end{matrix} ]$$

$$and$$

$${θ}_{2} = [ \begin{matrix}{x}_{2 , 1} \\ {x}_{2 , 2} \\ ⋮ \\ {x}_{2 , n}\end{matrix} ] . \\ \begin{matrix}RMSD ( {θ}_{1} , {θ}_{2} ) = \sqrt{MSE ( {θ}_{1} , {θ}_{2} )} \\ = \sqrt{E ( {( {θ}_{1} - {θ}_{2} )}^{2} )} \\ = \sqrt{\frac{{\sum }_{i = 1}^{n} {( {x}_{1 , i} - {x}_{2 , i} )}^{2}}{n}} .\end{matrix}$$

Since the ideal value of RMSD is 0 (which occurs when the calculated sensor readings equate to the measured sensor readings), a low value of RMSD is desired. A metric or threshold which defines the range of an acceptable RMSD value can be implemented in some embodiments of the present invention.

Depending on the results of the calibration verification, the IMS may return directly to step 18 and proceed with previously available input data (while also updating the environmental condition of the data center in step 18) if the CFD model is determined to be calibrated, or it may return to step 12 and regather physical and logical characteristics of the data center and data center objects, as detailed in steps 12-18, if the CFD model is determined to not be calibrated.

The initial verification of calibration and the subsequent calibration of a CFD model may improve the accuracy of a resulting CFD model output, which may translate into more accurate predictions of a data center environment. Additionally, the embodiments of the present invention which employ dynamic tracking of data center assets and environmental variables may shorten the time between the sampling of variables needed to build a CFD model and subsequent verification of calibration thereof. Such a reduction in time may avoid changes within a data center which may impact the output of a CFD model, and thus contribute to a more accurate CFD model, resulting in better-predicted outputs.

Once it has been determined at step 28 that the CFD model does not require verification of calibration, the CFD data is formatted according to the user's need 36 and outputted as necessary 38. The CFD data may be outputted in any number of ways, including visual representation on a screen visible to a user and/or as a data set useable by the IMS for further tasks/processing.

After a CFD model is calibrated to the physical elements of the datacenter further models of proposed changes to the datacenter can be predicted with outcomes in terms of temperature, airflow, and other thermodynamic factors. A comparison of the variances across multiple simulated models (for example, models simulating the placement of new equipment in different locations) can lead to identification of models having favorable results. Such favorable results may be based on any number of user- or system-defined criteria including, but not limited to, thermal performance, efficiency, cost savings, and the like.

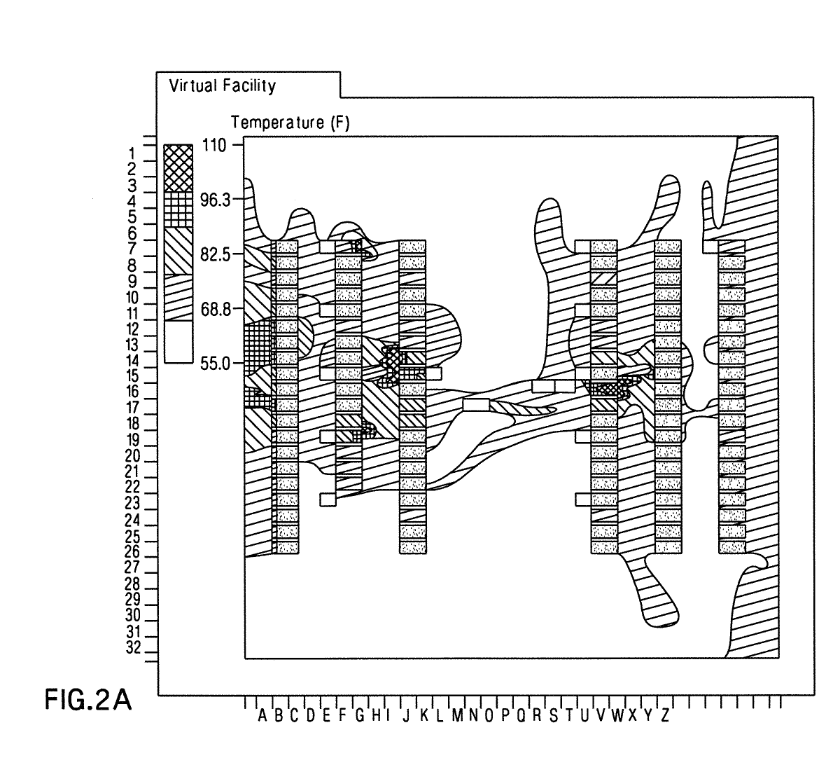

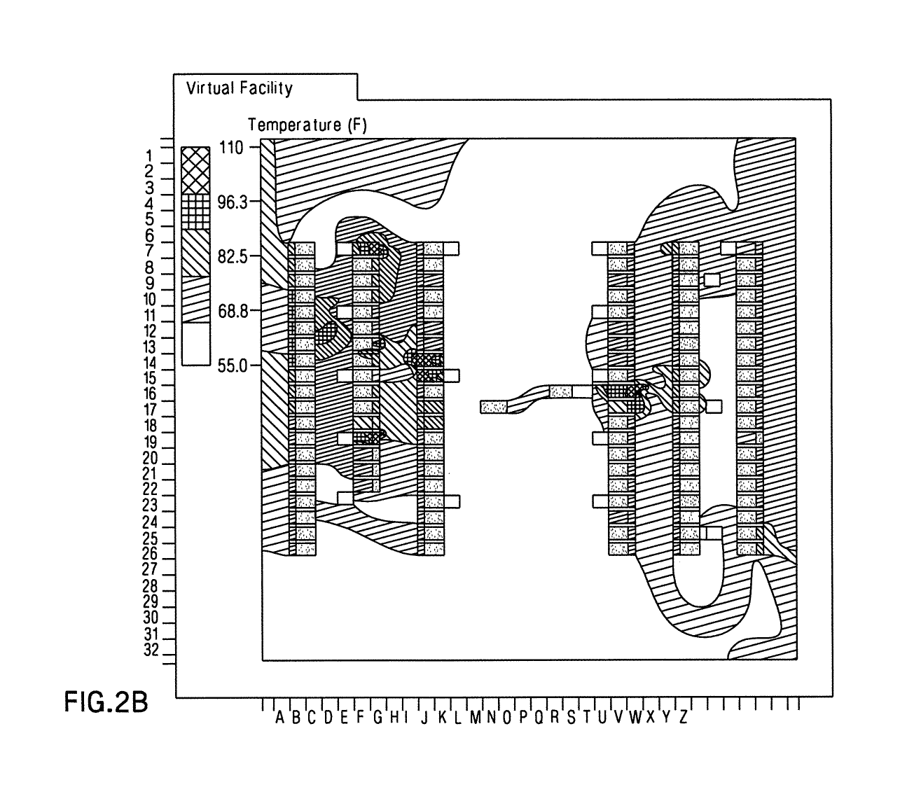

Examples of CFD models generated by the present invention are illustrated in FIGS. 2A and 2B. In one embodiment, the model of FIG. 2A can be the base model showing the temperature and airflow in a data center prior to any changes and FIG. 2B can be a predicted model based on proposed changes. The differences between the two models may allow a user to more easily realize potential benefits and/or disadvantages of any moves, adds, and changes relative to the then-present configuration. Alternatively, FIGS. 2A and 2B may both be models based on proposed changes. Seeing two potential results may allow a user to better chose a particular configuration over another. The models shown in FIGS. 2A and 2B can be an output of a particular task request embedded in an IMS. In some embodiments these models can be displayed side-by-side to ease visual comparison. The process of selecting improved options for placing particular equipment in certain portions of the datacenter can lead to an improved utilization of the given datacenter infrastructure and potentially deferring expansion needs.

Other embodiment of the present invention can include methods which comprise receiving a model framework (which can include any of the information inputted in steps 12 through 18) and proposed changes in infrastructure, and generating a CFD output in the form of predicted thermodynamic behavior (e.g., temperature, air flow, air pressure, heat energy, power, etc.) anywhere in a given space and not necessarily coincident with sensor positioning.

One value-added proposal of the presently claimed invention may be the time- and cost-savings produced by providing a framework to allow on-demand, dynamic updating of data center thermal models as MAC (Move, Add, Change) work orders are executed by data center personnel. The process outlined in FIG. 1 may result in a validated refinement of a data center room model with each and every equipment change in a relatively short period of time and without unnecessary manual intervention. A framework which maintains a regularly updated and validated thermal model of a data center may allow for the use of CFD and other modeling techniques to enhance data center commissioning, provisioning, and capacity planning activities in a cost-effective manner.

Note that while this invention has been described in terms of one or more embodiment(s), these embodiment(s) are non-limiting (regardless of whether they have been labeled as exemplary or not), and there are alterations, permutations, and equivalents, which fall within the scope of this invention. It should also be noted that there are many alternative ways of implementing the methods and apparatuses of the present invention. It is therefore intended that claims that may follow be interpreted as including all such alterations, permutations, and equivalents as fall within the true spirit and scope of the present invention.

We claim:

1. A system for computing thermodynamic behavior within a data center, said system comprising:
an electronic device for executing at least one module thereon, said at least one module including:
a data acquisition module for obtaining and storing input information, said input information including at least one of data center asset information, data center physical characteristics, asset tracking information, and environmental condition information;
a data solving module for accepting and analyzing said input information to output an output data packet, said output data packet comprising a predicted thermodynamic behavior model of said data center;
a data model validation module for validating the accuracy of said predicted thermodynamic behavior model of said data center against actual behavior of said data center; and
a data model output module for formatting and outputting said output data packet.

2. The system of claim 1, wherein said data solving module uses computational fluid dynamics analysis for analyzing said input information.

3. The system of claim 1, wherein said data model validation module validates the accuracy of said predicted thermodynamic behavior model by computing a root mean square error value against said actual behavior of said data center.

4. The system of claim 1, wherein said at least one module is part of an infrastructure management software.

5. The system of claim 1, wherein said input information is obtained via at least one discovery apparatus.

6. The system of claim 5, wherein said input information is obtained dynamically.

7. The system of claim 1, wherein said input information is inputted manually.

8. The system of claim 1, wherein said formatting and outputting said output data packet includes visually representing said predicted thermodynamic behavior model of said data center.

9. The system of claim 1, wherein said predicted thermodynamic behavior model of said data center includes temperature and air flow.

10. A method of computing thermodynamic behavior within a data center, said method comprising the steps of:
obtaining and storing on an electronic device input information, said input information including at least one of data center asset information, data center physical characteristics, asset tracking information, and environmental condition information;
analyzing said input information to produce an output data packet, said output data packet comprising a predicted thermodynamic behavior model of said data center;
validating the accuracy of said predicted thermodynamic behavior model of said data center against actual behavior of said data center; and
formatting and outputting said output data packet.

11. The method of claim 10, wherein said step of analyzing said input information includes using computational fluid dynamics analysis.

12. The method of claim 10, wherein said step of validating the accuracy of said predicted thermodynamic behavior model of said data center against actual behavior of said data center includes computing a root mean square error value of said predicted thermodynamic behavior model of said data center against said actual behavior of said data center.

13. The method of claim 10, wherein said step of obtaining and storing input information includes detecting said input information via at least one discovery apparatus.

14. The method of claim 10, wherein said step of obtaining and storing input information includes dynamically detecting said input information via at least one discovery apparatus.

15. The method of claim 10, wherein said step of obtaining and storing input information includes manually inputting said input information.

16. The method of claim 10, wherein said step of formatting and outputting said output data packet includes visually representing said predicted thermodynamic behavior model of said data center.

17. A system for computing thermodynamic behavior within a data center, said system comprising:
an electronic device for executing computer software thereon; and
an infrastructure management software executed on said electronic device, wherein said infrastructure management software includes:
a data acquisition module for obtaining and storing input information, said input information including at least one of data center asset information, data center physical characteristics, asset tracking information, and environmental condition information;
a data solving module for accepting and analyzing said input information to output an output data packet, said output data packet comprising a predicted thermodynamic behavior model of said data center;
a data model validation module for validating the accuracy of said predicted thermodynamic behavior model of said data center against actual behavior of said data center; and
a data model output module for formatting and outputting said output data packet.

18. The system of claim 17, wherein said data model validation module validates the accuracy of said predicted thermodynamic behavior model by computing a root mean square error value against said actual behavior of said data center.

19. The system of claim 17, wherein said data solving module uses computational fluid dynamics analysis for analyzing said input information.

20. The system of claim 17, wherein said input information is obtained via at least one discovery apparatus.
